(19) United States
(12) Patent Application Publication
(10) Pub. No.: US 2004/0243412 A1
(43) Pub. Date: Dec. 2, 2004

(54) Adaptation of speech models in speech recognition

(76) Inventors: Sunil K. Gupta, Edison, NJ (US); Prabhu Raghavan, Edison, NJ (US)

Correspondence Address: Steve Mendelsohn, Mendelsohn & Associates, P.C., 1515 Market Street, Suite 715, Philadelphia, PA, 19102, US

(21) Appl. No.: 10/447,906

(22) Filed: May 29, 2003

(51) Int. Cl. G10L 15/04

(52) U.S. Cl. 704/254

(57) ABSTRACT

A computer-based automatic speech recognition (ASR) system generates a sequence of text material used to train the ASR system. The system compares the sequence of text material to inputs corresponding to a user's speech utterances of that text material in order to update the speech models (e.g., phoneme templates) used during normal ASR processing. The ASR system is able to generate a user-dependent sequence of text material for adapting the speech models, where at least some of the text material is based on the evaluation of previous user utterances. In this way, the system can be trained more efficiently by concentrating on particular speech models that are more problematic than others for the particular user (or group of users).

### CROSS-REFERENCE TO RELATED APPLICATIONS

The subject matter of this application is related to U.S. patent application Ser. No. 10/188,539 filed Jul. 3, 2002 as attorney docket no. Gupta 8-1-4 (referred to herein as “the Gupta 8-1-4 application”), the teachings of which are incorporated herein by reference.

### BACKGROUND OF THE INVENTION

1. Field of the Invention

The present invention relates to automatic speech recognition (ASR) and, in particular, to the adaptation of speech models used during ASR.

2. Description of the Related Art

Computer-based automatic speech recognition systems are designed to automatically determine text associated with voiced speech inputs (i.e., utterances). In certain implementations, ASR systems compare parametric representations (e.g., based on Markov models) of a user's utterances to parametric models (i.e., templates) of words or parts of words (e.g., phonemes) stored in a template database. Based on these comparisons, an ASR system identifies the text-based words and phrases that most closely match the user's utterances based on some appropriate distance measure in the parametric domain.

For certain computer applications, such as ASR-based word processing, it is known to train an ASR system for the particular speech characteristics of an individual user (or group of users). During such training, the computer application presents a sequence of text (e.g., a list of words and phrases) for the user to pronounce. As the user provides utterances for the known text, the computer application modifies the corresponding parametric models stored in the template database to adapt the models for the user's particular speech characteristics. In order to effectively train an ASR system, the user is typically instructed to pronounce a predetermined sequence of text that represents the wide range of speech characteristics that may, in theory, differ across a population of potential users, where the text sequence is independent of the actual speech characteristics of the current user. A critical problem with such online adaptation is that the amount of speech material that is typically recorded before all phonemes are well represented and sufficiently adapted is quite high.

### SUMMARY OF THE INVENTION

Problems in the prior art are addressed in accordance with the principles of the invention by a computer application having an automatic speech recognition (ASR) system, where the application automatically generates a user-dependent sequence of text used to train the ASR system.

Online adaptation is achieved by modifying the speech models (e.g., phoneme templates) used by the ASR system, based on utterances collected from the user for specific text material (i.e., a sequence of adaptation text), in order to better match the user's speech characteristics. Speech utterances are analyzed with respect to the adaptation text, and the quality of the articulation is evaluated using an appropriate pronunciation-scoring algorithm. If the algorithm determines that a particular phoneme's production is bad, then the template for that phoneme is determined to be “farther” from the user's speech. To improve the ability of the ASR system to recognize the user's speech, the template for that phoneme is modified to more closely match the user's speech. In order to ensure that the adaptation of the template for that phoneme is appropriate, it is better to rely on a number of different utterances containing that phoneme. As the phoneme template is modified, the pronunciation score for that phoneme should improve.

Using the pronunciation-scoring algorithm, the application determines those phoneme templates that have the most problems with respect to “closeness” to the user's speech. The application can then select appropriate additional adaptation text tailored for the particular user. Unlike prior art online adaptation methods that present static text, an application of the present invention can present text material that is varied on the basis of the quality of the speech templates after each adaptation step. Since the application is aware of the phoneme templates that have problems, specific text material that is rich in the problem phonemes can be presented. This allows for faster adaptation times, since the adaptation is very focused on the problem phonemes rather than trying to adapt all phoneme templates (including those that are not a problem for the particular user).

In one embodiment, the invention is a computer system comprising a database of speech models, a speech recognition (SR) engine, an adaptation module, a pronunciation evaluation module, and a sequence generator. The SR engine is adapted to compare user utterances to the database of speech models to recognize the user utterances. The adaptation module is adapted to modify the database of speech models based on a set of user utterances corresponding to a set of known inputs. The pronunciation evaluation module is adapted to characterize user utterances relative to corresponding speech models in the database. The sequence generator is adapted to generate the set of known inputs used by the adaptation module to modify the database of speech models, wherein the sequence generator automatically selects at least a subset of the known inputs based on the characterization of previous user utterances by the pronunciation evaluation module.

In another embodiment, the invention is a computer-based method for training a computer application having a speech recognition engine adapted to compare user utterances to a database of speech models to recognize the user utterances. The method comprises generating a set of known inputs; modifying the database of speech models based on a set of user utterances corresponding to the set of known inputs; and characterizing user utterances relative to corresponding speech models in the database, wherein at least a subset of the known inputs are automatically selected based on the characterization of previous user utterances.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 shows a block diagram depicting the components of an automatic speech recognition (ASR) system used to train the ASR system, according to one embodiment of the present invention; and

FIG. 2 shows a flow diagram of the processing implemented by the ASR system of FIG. 1 to adapt, for a particular user or group of users, the phoneme templates used during speech recognition processing, according to one embodiment of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

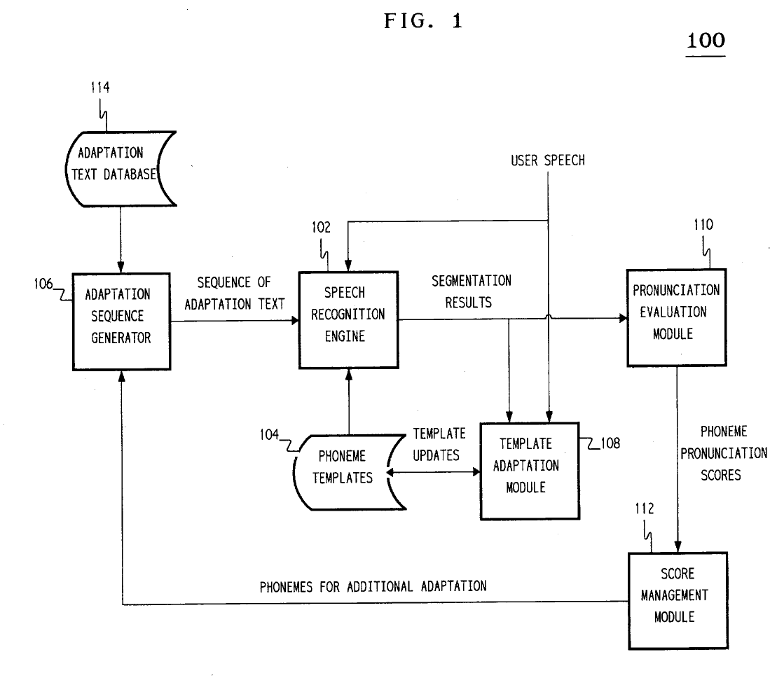

FIG. 1 shows a block diagram depicting the components of an automatic speech recognition (ASR) system 100 used to train the ASR system, according to one embodiment of the present invention. ASR system 100 may be part of a larger system that relies on automatic speech recognition for at least some of its processing. Although preferably implemented in software on a conventional personal computer (PC), ASR system 100 may be implemented using any suitable combination of hardware and software on an appropriate processing platform.

ASR system 100 supports (at least) two modes of operation: a training mode and a speech recognition mode. During the speech recognition mode, ASR system 100 processes inputs corresponding to a user's speech utterances in order to identify text corresponding to those utterances. To achieve this function, ASR system 100 has a speech recognition (SR) engine 102 that compares user utterances to speech models (e.g., phoneme templates) stored in a template database 104 in order to recognize the text associated with those utterances. In preferred implementations, the comparison is performed in a suitable parametric domain (e.g., based on linear prediction cepstral coefficients), where the database provides mappings for different phonemes between the text domain and the parametric domain.

The ability of SR engine 102 to accurately recognize a user's speech is directly related to the appropriateness for the particular user of the speech models stored in template database 104. In order to provide a speech recognition tool that can be adapted for a particular user or group of users, ASR system 100 has additional components that support the training mode of operation, in which the speech models contained in template database 104 are adapted based on user utterances corresponding to known adaptation text material.

In particular, adaptation sequence (AS) generator 106 generates a sequence of adaptation text for presentation to the user (e.g., on a graphical display) to prompt the user to provide speech utterances corresponding to the known words and phrases in that sequence. SR engine 102 compares the user speech inputs to the known adaptation text to generate segmentation results that identify parts of the user speech corresponding to particular phonemes represented in template database 104. Template adaptation (TA) module 108 uses the segmentation results from SR engine 102 and the user speech inputs to update the speech models stored in template database 104 for some or all of the phonemes contained in the words and phrases of the adaptation text. TA module 108 may implement any suitable algorithm for adapting the phoneme templates stored in database 104. Such algorithms include, for example, maximum likelihood linear regression, maximum a posteriori adaption methods, codeword-dependent cepstral normalization, vocal tract length normalization techniques, neural network-based model transformation, and parametric speech data transformation techniques.

According to the present invention, AS generator 106 is able to generate a user-dependent sequence of adaptation text that is tailored to the particular speech characteristics of the current user or group of users, for use in adapting the speech models in template database 104. To achieve that goal, ASR system 100 has a pronunciation evaluation (PE) module 110 and a score management (SM) module 112. These modules operate to evaluate the appropriateness of the existing phoneme templates in database 104 for the current user and identify those phonemes for which the phoneme templates are not sufficiently adapted for the user.

In particular, PE module 110 compares the user's articulation of a target word or phrase with the corresponding model-based articulation for the known word/phrase generated by SR engine 102 using the corresponding phoneme templates in database 104. In one implementation, PE module 110 employs confidence measures that make a determination regarding the accuracy of the processing of SR engine 102. Alternatively, PE module 110 uses pronunciation-scoring algorithms such as those described in the Gupta 8-1-4 application. Such algorithms produce a score of the quality of the user's articulation of each phoneme in the adaptation text. “Higher” scores correspond to phonemes for which the speech models in database 104 more closely match the user's articulation of those phonemes.

Score management module 112 collects the phoneme pronunciation scores generated by PE module 110 and identifies phonemes with sufficiently low scores (e.g., lower than a specified threshold level in the corresponding “pronunciation score” space). These “problem phonemes” are passed back to adaptation sequence generator 106, which is capable of selecting additional adaptation text material that is rich in or otherwise emphasizes the problem phonemes. In one implementation, AS generator 106 queries a database 114 of words and phrases in order to generate this additional adaptation text. Adaptation text database 114 is a large corpus of phrase text material that has maps of different phonemes to words and phrases that contain those phonemes. In one implementation, adaptation sequences are generated from adaptation text database 114 by querying it for one or more phonemes and creating a list of words and phrases that are rich in those phonemes. In another implementation, phrases can be created automatically using algorithms that combine words obtained from adaptation text database 114 that contain the target phonemes, while applying various grammar constraints of the target language.

In a preferred implementation, adaptation sequence generator 106 generates adaptation text in a text domain. In particular, the pronunciation of the adaptation text generated by AS generator 106 is represented by a corresponding set of phonemes identified by their phonetic characters. SR engine 102 takes the user utterance of the adaptation text that is in an appropriate parametric domain (e.g., based on linear prediction cepstral coefficients) and segments it for every phoneme in the adaptation phrase using some criterion that optimizes the selection of each segment. This is achieved using the speech models for the different phonemes from phoneme template database 104. Phoneme template database 104 contains mappings for different phonemes between the text domain and the parametric domain. The phoneme templates are typically built from a large speech database representing “correct” phoneme pronunciations. One possible form of speech templates is as Hidden Markov Models (HMMs), although other approaches such as neural networks and dynamic time-warping can also be used. SR engine 102 generates segmentation results by comparing the parametric representation of the adaptation text to an analogous parametric representation of the user speech input.

Depending on the implementation, ASR system 100 may have additional components that present the adaptation text to the user, capture the user's utterances, play back speech data to the user, and present additional cues such as images or video clips.

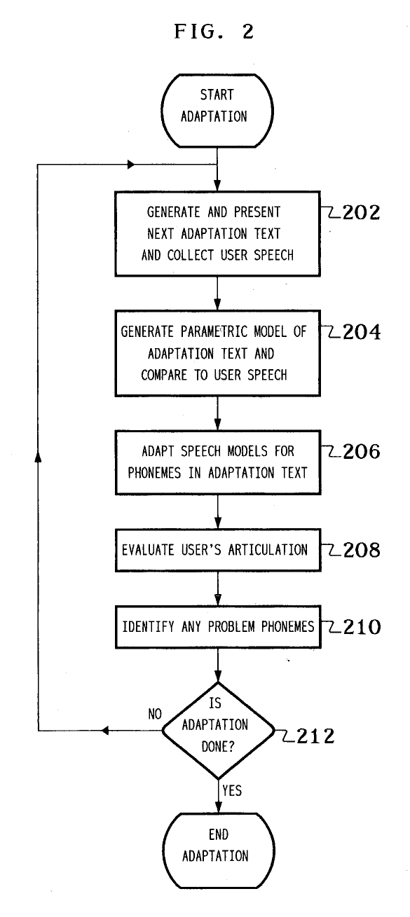

FIG. 2 shows a flow diagram of the processing implemented by ASR system 100 of FIG. 1 to adapt, for a particular user or group of users, the phoneme templates used during speech recognition processing, according to one embodiment of the present invention. In a preferred implementation, the adaptation processing of FIG. 2 begins with a predetermined, generalized set of adaptation text that may be selected to quickly characterize a wide variety of phonemes. As the adaptation process continues and sufficient results have been collected to confidently characterize the appropriateness of the stored speech models, ASR system 100 begins to select additional adaptation text that focuses on problem phonemes identified for the current user.

In particular, referring to both FIGS. 1 and 2, after invoking the adaptation process, adaptation sequence generator 106 generates and presents an initial set of adaptation text and the ASR system collects the corresponding speech inputs from the user (step 202). Depending on the implementation, each different set of adaptation text may be a word, a phrase, a sentence, a paragraph, or even more. Speech recognition engine 102 generates a parametric representation of the current adaptation text based on the speech models in template database 104 and compares that parametric representation to an analogous parametric representation of the user speech input to generate segmentation results (step 204). Template adaptation module 108 uses the segmentation results and the parametric representation of user's speech inputs in order to adapt the phoneme templates corresponding to the phonemes in the current adaptation text (step 206).

Pronunciation evaluation module 110 also uses the segmentation results to evaluate the user's articulation and generate pronunciation scores for the corresponding phonemes (step 208). Score management module 112 collects these phoneme pronunciation scores and identifies any problem phonemes (step 210). If the adaptation processing is done (step 212), then the processing of FIG. 2 is terminated. Otherwise, processing returns to step 202, where adaptation sequence generator 106 uses the problem phonemes, if any, identified by SM module 112 to select or generate additional sets of adaptation text that are tailored to focus on the user's problem phonemes. By automatically identifying and focusing on problem phonemes, the adaptation processing of FIG. 2 adapts the phoneme templates in an effective and efficient manner.

Depending on the particular implementation, the adaptation processing of FIG. 2 may terminate in a number of different ways. In one scenario, the processing will continue until all of the speech models in template database 104 sufficiently match the user's articulation of the corresponding phonemes. In this case, the user-dependent adaptation processing of the present invention will still typically be quicker than the user-independent adaptation processing of the prior art, since the prior art processing covers all phonemes, even those that are not problems for the particular user, while the processing of the present invention is able to concentrate on the problem phonemes instead of spending a lot of time on “non-problem” phonemes.

In another scenario, a user may manually terminate the adaptation process. In this case, the user-dependent processing of FIG. 2 ensures maximal gain for the user's time by concentrating on problem phonemes first.

After the adaptation processing of FIG. 2 has terminated, ASR system 100 may be operated in the speech recognition mode, in which SR engine 102 identifies the text associated with the user's speech input relying on stored phoneme templates that have been efficiently adapted to the particular user, thereby providing more reliable speech recognition processing.

Embodiments of the present invention may provide one or more of the following benefits:

Only those speech models that do not show an acceptable degree of “closeness” to the user's input need to be adapted. This is beneficial since a critical but not small amount of data is typically needed to successfully adapt a given phoneme template. By avoiding these “non-problem” phonemes, a significant amount of adaptation time can be saved.

Stimulus data rich in the problem phonemes can be collected from the user, instead of the usual generalized phrases of the prior art, to get a greater amount of data coverage for these problem phonemes. This approach can (I) significantly reduce the amount of stimulus data used, (2) speed up the adaptation of the speech models, and (3) improve the performance of the resulting models.

In a speech therapy or foreign language instruction application, the present invention can be used to adapt the speech models to a specific therapist/teacher for which prior art applications do not work well, either due to regional dialect differences or the therapist/teacher's own speech problems. In this case, the speech templates can be adapted to work better for the particular therapist/teacher.

Although the present invention has been described in the context of the adaptation of speech models that correspond to phoneme templates, the invention is not so limited. In general, the invention can be implemented for any suitable speech models, including, without limitation, those that correspond to groups of phonemes and/or whole words.

Similarly, although the present invention has been described in the context of certain processing being implemented in a parametric domain, the invention can in theory be implemented in any suitable domain, including, without limitation, an appropriate text domain.

The invention may be implemented as circuit-based processes, including possible implementation as a single integrated circuit, a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The invention can be embodied in the form of methods and apparatuses for practicing those methods. The invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

We claim:

1. A computer system comprising:
(a) a database of speech models;
(b) a speech recognition (SR) engine adapted to compare user utterances to the database of speech models to recognize the user utterances;
(c) an adaptation module adapted to modify the database of speech models based on a set of user utterances corresponding to a set of known inputs;
(d) a pronunciation evaluation module adapted to characterize user utterances relative to corresponding speech models in the database; and
(e) a sequence generator adapted to generate the set of known inputs used by the adaptation module to modify the database of speech models, wherein the sequence generator automatically selects at least a subset of the known inputs based on the characterization of previous user utterances by the pronunciation evaluation module.

2. The invention of claim 1, wherein the speech models are phoneme templates in a parametric domain.

3. The invention of claim 1, wherein, using the database of speech models, the SR engine generates and compares parametric representations of the set of known inputs to parametric representations of the user utterances to generate segmentation results for use by the adaptation module and the pronunciation evaluation module.

4. The invention of claim 1, further comprising a score management module adapted to collect results from the pronunciation evaluation module and identify one or more problem phonemes, wherein the sequence generator selects additional known inputs for the set of known inputs based on the one or more problem phonemes.

5. The invention of claim 4, wherein the score management module thresholds phoneme pronunciation scores from the pronunciation evaluation module to identify the one or more problem phonemes.

6. The invention of claim 1, wherein the generation of known inputs for adaptation of speech models in the database automatically terminates when the system determines that all of the speech models are sufficiently adapted.

7. The invention of claim 1, wherein:
the speech models are phoneme templates in a parametric domain;
using the database of speech models, the SR engine generates and compares parametric representations of the set of known inputs to parametric representations of the user utterances to generate segmentation results for use by the adaptation module and the pronunciation evaluation module;
further comprising a score management module adapted to collect results from the pronunciation evaluation module and identify one or more problem phonemes, wherein:
the sequence generator selects additional known inputs for the set of known inputs based on the one or more problem phonemes; and
the score management module thresholds phoneme pronunciation scores from the pronunciation evaluation module to identify the one or more problem phonemes; and
the generation of known inputs for adaptation of speech models in the database automatically terminates when the system determines that all of the speech models are sufficiently adapted.

8. A computer-based method for training a computer application having a speech recognition (SR) engine adapted to compare user utterances to a database of speech models to recognize the user utterances, the method comprising:
generating a set of known inputs;
modifying the database of speech models based on a set of user utterances corresponding to the set of known inputs; and
characterizing user utterances relative to corresponding speech models in the database, wherein at least a subset of the known inputs are automatically selected based on the characterization of previous user utterances.

9. The invention of claim 8, wherein the speech models are phoneme templates in a parametric domain.

10. The invention of claim 8, wherein, using the database of speech models, the SR engine generates and compares parametric representations of the set of known inputs to parametric representations of the user utterances to generate segmentation results for use in modifying the database and characterizing the user utterances.

11. The invention of claim 8, further comprising collecting results from the pronunciation evaluation module and identifying one or more problem phonemes, wherein additional known inputs are selected for the set of known inputs based on the one or more problem phonemes.

12. The invention of claim 11, wherein phoneme pronunciation scores are thresholded to identify the one or more problem phonemes.

13. The invention of claim 8, wherein the generation of known inputs for adaptation of speech models in the database automatically terminates when it is determined that all of the speech models are sufficiently adapted.

14. The invention of claim 8, wherein:
the speech models are phoneme templates in a parametric domain;
using the database of speech models, the SR engine generates and compares parametric representations of the set of known inputs to parametric representations of the user utterances to generate segmentation results for use in modifying the database and characterizing the user utterances;
further comprising collecting results from the pronunciation evaluation module and identifying one or more problem phonemes, wherein:
additional known inputs are selected for the set of known inputs based on the one or more problem phonemes; and
phoneme pronunciation scores are thresholded to identify the one or more problem phonemes; and
the generation of known inputs for adaptation of speech models in the database automatically terminates when it is determined that all of the speech models are sufficiently adapted.

15. A machine-readable medium, having encoded thereon program code, wherein, when the program code is executed by a machine, the machine implements a method for training a computer application having a speech recognition (SR) engine adapted to compare user utterances to a database of speech models to recognize the user utterances, the method comprising:
generating a set of known inputs;
modifying the database of speech models based on a set of user utterances corresponding to the set of known inputs; and
evaluating the user utterances, wherein at least a subset of the known inputs are automatically selected based on the evaluation of previous user utterances.

16. The invention of claim 15, wherein, using the database of speech models, the SR engine generates and compares parametric representations of the set of known inputs to parametric representations of the user utterances to generate segmentation results for use in modifying the database and characterizing the user utterances.

17. The invention of claim 15, further comprising collecting results from the pronunciation evaluation module and identifying one or more problem phonemes, wherein additional known inputs are selected for the set of known inputs based on the one or more problem phonemes.

18. The invention of claim 17, wherein phoneme pronunciation scores are thresholded to identify the one or more problem phonemes.

19. The invention of claim 15, wherein the generation of known inputs for adaptation of speech models in the database automatically terminates when it is determined that all of the speech models are sufficiently adapted.

20. The invention of claim 15, wherein:
the speech models are phoneme templates in a parametric domain;
using the database of speech models, the SR engine generates and compares parametric representations of the set of known inputs to parametric representations of the user utterances to generate segmentation results for use in modifying the database and characterizing the user utterances;
further comprising collecting results from the pronunciation evaluation module and identifying one or more problem phonemes, wherein:
additional known inputs are selected for the set of known inputs based on the one or more problem phonemes; and
phoneme pronunciation scores are thresholded to identify the one or more problem phonemes; and
the generation of known inputs for adaptation of speech models in the database automatically terminates when it is determined that all of the speech models are sufficiently adapted.
